(19) United States
(12) Patent Application Publication
(10) Pub. No.: US 2003/0151631 A9
(43) Pub. Date: Aug. 14, 2003

(54) Printing service system and print service method

(75) Inventors: Akira Miyata, Tokyo (JP); Jin Nakayama, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/091,269

(22) Filed: Mar. 4, 2002

(30) Foreign Application Priority Data
Mar. 6, 2001 (JP) 2001-061848

(51) Int. Cl. G09G 5/00

(52) U.S. Cl. 345/838

(57) ABSTRACT

According to the present invention, a portable information terminal is connected via a network to a server capable of delivering a main image and a thumbnail image that corresponds to the main image, thereby acquiring the thumbnail image or image number. Then, the main image stored in the server, the main image corresponding to the thumbnail image, is printed out by a printer connected via the network in accordance with a command from the portable information terminal via the network.

### CROSS-REFERENCE TO RELATED APPLICATIONS

This application is based upon and claims the benefit of priority from the prior Japanese Patent Application No. 2001-061848, filed Mar. 6, 2001, the entire contents of which are incorporated herein by reference.

### BACKGROUND OF THE INVENTION

1. Field of the Invention

In recent years, a print bending machine for easily printing a digital image is installed at a convenience store or photography shop. Unlike a silver salt photography requiring chemical processing, by using the above vending machine, it is possible for a customer to individually print a digital image without the assistance of a clerk, as with an automatic vending machine. In addition, there is provided an image service site for storing image data on a server over the Internet, and making a print request there, thereby making it possible to receive a print image through a courier or at a convenience store.

2. Description of the Related Art

In the prior art, where a digital image is printed by a print vending machine at a shop, it is required to record desired image data in a medium such as a memory card, bring the medium to the shop, and read the image data by the print vending machine. Thus, there has been a problem that image data must be transferred from a digital still camera or personal computer to media or bring media such as memory card having the data recorded therein. In addition, there has been a problem that, if a print request is made to the image service site, it takes a long until the requester receives the image data.

### BRIEF SUMMARY OF THE INVENTION

According to one aspect of the present invention, a printing service system comprises: a service device which comprises a storage portion having a main image and a thumbnail image stored therein; a portable information device which provides access to the server device via a network to receive a desired thumbnail image and its number from the storage device, and transmits the image number to a printing device, corresponding to the thumbnail image; and a printing device which downloads and prints the main image which corresponds to the thumbnail image specified from the portable information device from the server device via the network.

According to another aspect of the present invention, a printing apparatus comprises: a communication portion which carries out external data transmission/receiving via a network; a control portion which receives information for specifying an image via the communication portion, and externally downloads image data based on information for specifying the received image; a coin charge portion which receives a coin; and a printing portion which prints the image data on paper.

According to further aspect of the present invention, a server device comprises: a first storage portion having stored therein a main image and a thumbnail image corresponding to the main image; a second storage portion having a program stored therein;

a communication portion connected to a network to connect an external device; and a control portion which reading out the thumbnail image specified via the network from the first storage portion in accordance with a program stored by the second storage portion, followed by delivering the read out image from the communication portion to an external device via the network, and reads out the main image presented via the network from the first storage portion, followed by delivering the read out image from the communication portion to the external device via the network.

According to yet further aspect of the present invention, a service device program comprises: a step of transmitting a thumbnail number and an image number that corresponds thereto upon an external request via a network; a step of externally receiving the image number that corresponds to the thumbnail image via the network; and a step of externally delivering a larger amount of data than that of a thumbnail, the image corresponding to the received image number via the network.

According to yet further aspect of the present invention, a portable information device program comprises: a step of providing access from a portable information device to a printing device by a user operation; a step of causing a user to select a stored thumbnail; and a step of delivering the image number that corresponds to the thumbnail to the printing device.

According to yet further aspect of the present invention, a printing service system comprises: a server device which comprises a storage portion having a main image and a thumbnail image stored therein, the server device externally delivering the main image and thumbnail image and an image number; a portable information device which provides access to the server device via a network, thereby receiving a desired image number from the storage portion and transmitting the image number to the server device; and a printing device which downloads and prints the main image from the server device via the network in accordance with a command from the server.

According to yet further aspect of the present invention, a portable information device program comprises: a step of providing access from a portable information device to a server via a network by a user operation; a step of displaying image data delivered from the server; a step of causing the user to select a desired image from the displayed image; a step of prompting the user to deliver a print command to the server; and a step of causing the user to select a printer targeted for printing.

According to yet further aspect of the present invention, a printing service system comprises: a server device which comprises a storage portion having a main image and a thumbnail image stored therein; a portable information device which is provided with a storage section for storing a thumbnail image, a display section for displaying a thumbnail, and an input section for a user to input a command, and which provides access to the server device via a network to receive a desired thumbnail image and its number from the server device, and transmits the image number to a printing device, corresponding to the thumbnail image; and a printing device which downloads and prints the main image which corresponds to the image number specified from the portable information device from the server device via the network.

### BRIEF DESCRIPTION OF THE SEVERAL VIEWS OF THE DRAWING

FIG. 1A to FIG. 1D are block diagrams each showing a configuration of a digital print service system according to a first embodiment of the present invention, wherein FIG. 1B is a block diagram showing a configuration of an image service server 1 and an image database 2, FIG. 1C is a block diagram showing a configuration of a portable telephone set 3, and FIG. 1D is a block diagram showing a configuration of a print vending machine 4;

FIG. 2 is a conceptual view showing a data structure concerning image data stored in the image database according to the first embodiment;

FIG. 3 is a conceptual view illustrating general operation of the digital print service system according to the first embodiment;

FIG. 4 is a conceptual view illustrating general operation of the digital print service system according to the first embodiment;

FIG. 5 is a flowchart illustrating operation of the portable telephone set according to the first embodiment;

FIG. 6 is a flowchart illustrating operation of the portable telephone set according to the first embodiment;

FIG. 7 is a flowchart illustrating operation of the print vending machine according to the first embodiment;

FIG. 8 is a flowchart illustrating operation of the image service server according to the first embodiment;

FIG. 9 is a conceptual view illustrating general operation of a digital printing service system according to a second embodiment of the present invention;

FIG. 10 is a flowchart illustrating operation of a portable telephone set according to the second embodiment;

FIG. 11 is a flowchart illustrating operation of an image service server according to the second embodiment; and

FIG. 12 is a flowchart illustrating operation of a print vending machine according to the second embodiment.

### DESCRIPTION OF THE PREFERRED EMBODIMENTS

Hereinafter, preferred embodiments of the present invention will be described with reference to the accompanying drawings.

A. First Embodiment

A-1. Configuration of the First Embodiment

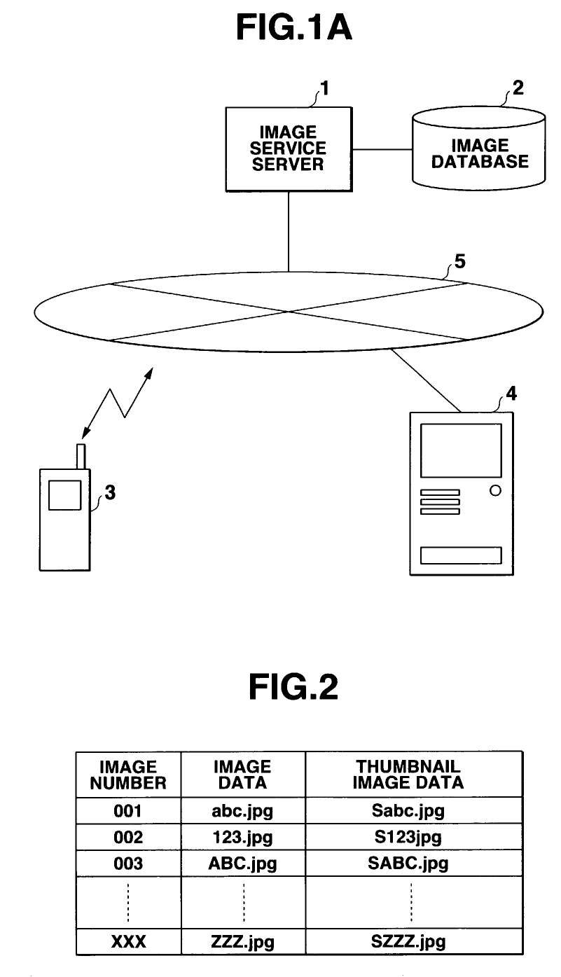

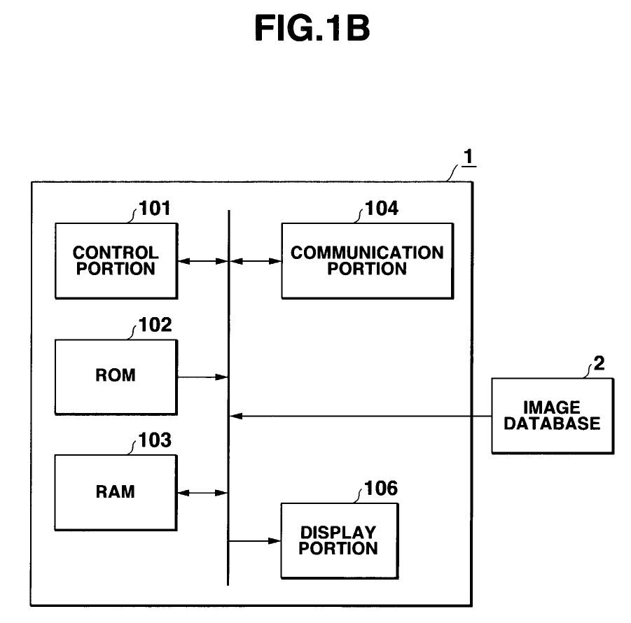

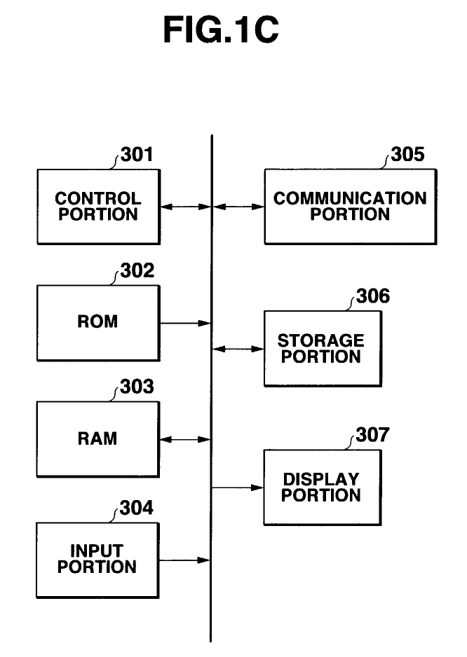

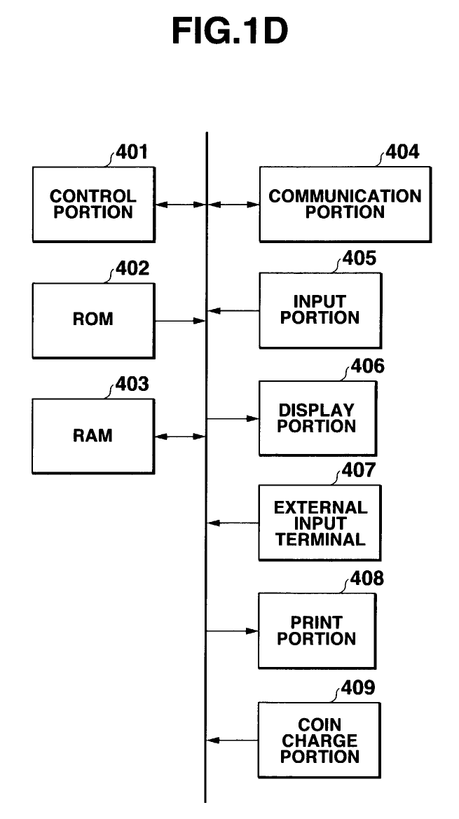

FIG. 1A is a block diagram showing a configuration of a digital print service system according to a first embodiment of the present invention. In the figure, an image service server 1 stores in an image database 2 a plurality of image data and thumbnail image data (reduced image data) of the image data. The image service server 1 is connected to a network 5 such as the Internet. The image data stored in the image database 2 is provided so as to be browsed as a Web page described in HTML (or in a format such that a terminal can browse data). In addition, the thumbnail image data of selected image data is transferred to the portable telephone set 3 upon a request from the above portable telephone set 3. Further, the image service server 1 transfers requested image data to a print vending machine 4 to be described later upon a request from the print vending machine 4.

Here, the above described configurations each will be described in more detail.

The image service server 1 and the image database 2 are configured as shown in FIG. 1B.

That is, the image service server 1 comprises: a control portion 101 which includes a microprocessor; a ROM (read only memory) 102 having a program stored therein; a temporary storage memory RAM (random access memory) 103; a display portion 106; and a communication portion 104 provided with a network connection modem or the like. This server is connected to the image database 2 provided as a larger capacity storage means.

Such image service server 1 controls the above described blocks each by operation of the control portion 101 in accordance with a program stored in the ROM 102 upon an external request via a network, and carries out operation presented in the following embodiment.

In addition, the portable telephone set 3 is configured as shown in FIG. 1C.

That is, the portable telephone set 3 comprises: a control portion 301 which includes a microprocessor; a ROM 302 having a program stored therein; a temporary storage memory RAM 303; an input portion 304 for a user to makes an input operation; a communication portion 305 provided with a network connection modem or the like; a flash memory 306 which stores telephone numbers, E-mail addresses and the like; and a display portion 307.

Then, the portable telephone set 3 controls the above described blocks each by operation of the control portion 301 in accordance with a program stored in the ROM 302 upon an external request via a user input or network, and carries out operation presented in the following embodiment.

Further, the print vending machine 4 is configured as shown in FIG. 1D.

That is, the print vending machine 4 comprises: a control portion 401 which includes a microprocessor; a ROM 402 having a program stored therein; a temporary storage memory RAM 403; a communication portion 405 provided with a network connection modem or the like; an input portion 405 and a display portion 406 provided as an interface with a user (i.e., customer); an external input terminal 497 which can be inserted into a removable memory such as a variety of memory cards; a print portion 408 which prints out digital image data; and a coin charge portion 409 for a customer to insert a coin.

Such print vending machine 4 controls the above described blocks each by operation of the control portion 401 in accordance with a program stored in the ROM 102 upon a request via customer key input or network, and carries out operation presented in the following embodiment.

FIG. 2 is a conceptual view showing a data structure concerning image data stored in the image database 2. In the image database 2, an image number, image data, and thumbnail image data of the image data are stored to be associated with each other. The image number is provided as identification information assigned to image data in order to identify image data. In addition, the thumbnail image data is remarkably small in data capacity as compared with original image data. The image service server 1 is provided to transfer the image number so as to be embedded in thumbnail image data when the thumbnail image data is transferred to a terminal. The image number may be embedded in thumbnail image data. Further, the above image data may be an image provided by a server management entity or may be (personal) image registered (transferred) in advance by a user or the like.

Turning to FIG. 1A, the portable telephone set 3 is used by a user who wants to print image data. The above image service server 1 is accessed via the network 5 in accordance with user operation so that the image data stored in the image database 2 can be browsed. In addition, the portable telephone set 3 requests the image service server 1 to download the thumbnail image data of an image when the user selects the image. Further, the portable telephone set 3 provides access to the print vending machine 4 described later via the network 5 in accordance with the user operation. Then, the image number assigned to (or embedded in) the thumbnail image data selected (specified) from among the user downloaded thumbnail image data is transmitted to the print vending machine 4.

Next, the print vending machine 4 is installed at a photography shop (photography print corner) or at a convenience store. When a medium such as memory card (not shown) are attached to an input terminal 407, image data recorded in the medium is read out, and printed on a predetermined form. In the first embodiment, in addition to the above described function, the print vending machine 4 accesses the image service server 1 upon a print request from the portable telephone set 3 that has provided access via the network 5 so as to download the image data that corresponds to the image number to be transmitted from the portable telephone set 3. In addition, the print vending machine 4 prints out the downloaded image data on a predetermined form by the user of the portable telephone set 3 inserting a predetermined coin in the coin charge portion 409.

A-2. Operation of First Embodiment

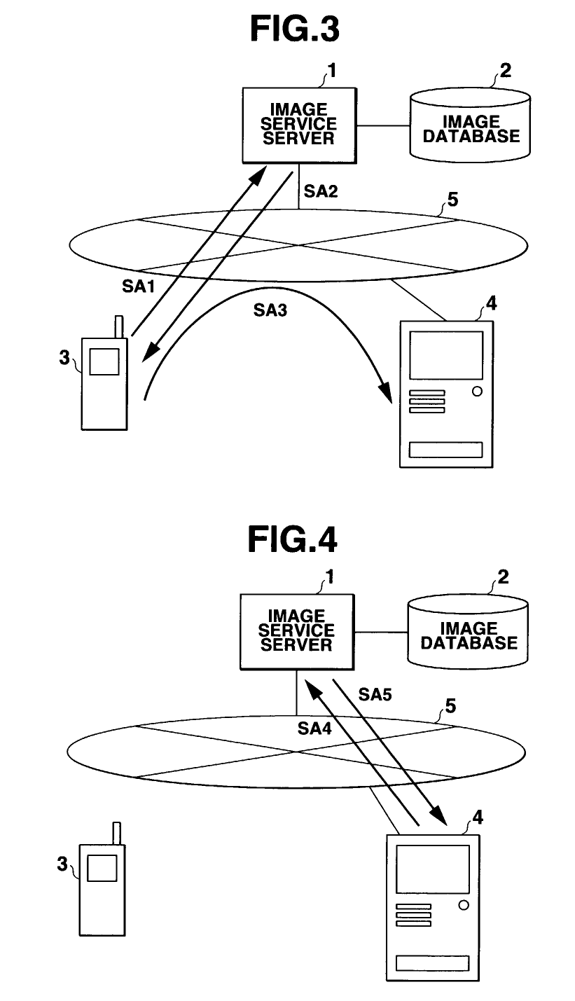

Now, an operation of the digital print service system according to the above described first embodiment will be described here. FIG. 3 and FIG. 4 are conceptual views each illustrating a general operation of the digital print service system according to the first embodiment.

First, the user obtains access to the image service server 1 via the network 5 by using the portable telephone set 3. Then, the user browses the image data stored in the image database 2 of the image service server 1, and selects a desired image (SA1). The portable telephone set 3 downloads the thumbnail image data of the image which is selected by the user from the image service server 1 via the network 5 (SA2). Next, the portable telephone set 3 provides access to the print vending machine 4 via the network 5, and transmits the image number of the thumbnail image data (SA3).

The print vending machine 4 having received the image number of the thumbnail image data immediately accesses the image service server 1 via the network 5 (SA4), and downloads the image data that corresponds to the image number (SA5). Next, the print vending machine 4 prints out the downloaded image data when the user having requested image data printing inserts coin in the coin charge portion 409. In this manner, the user receives a print from the print vending machine 4.

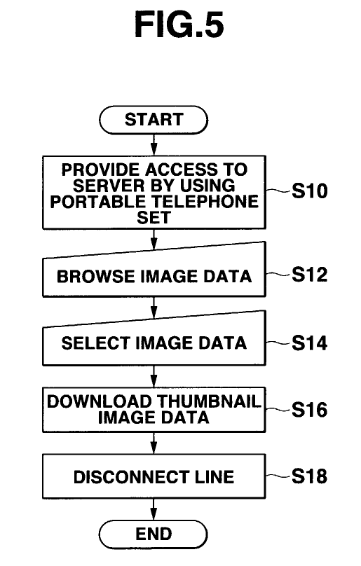

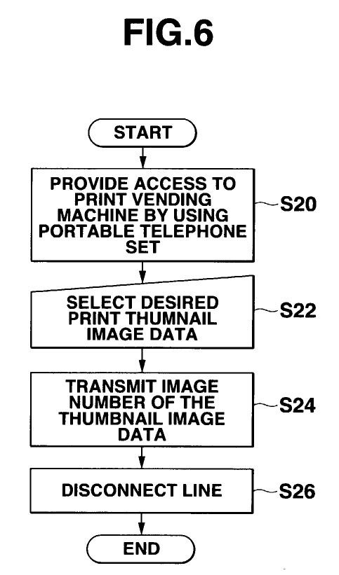

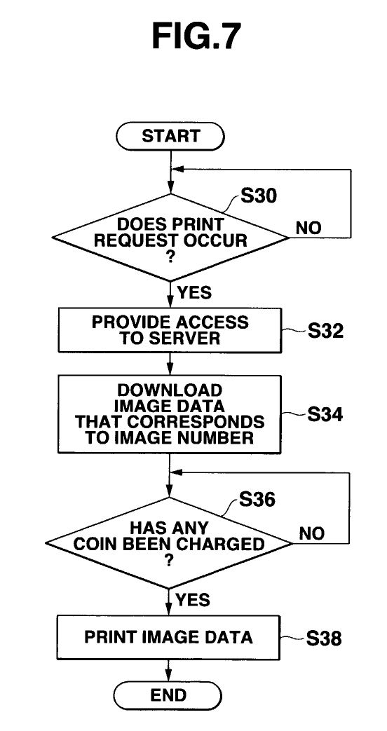

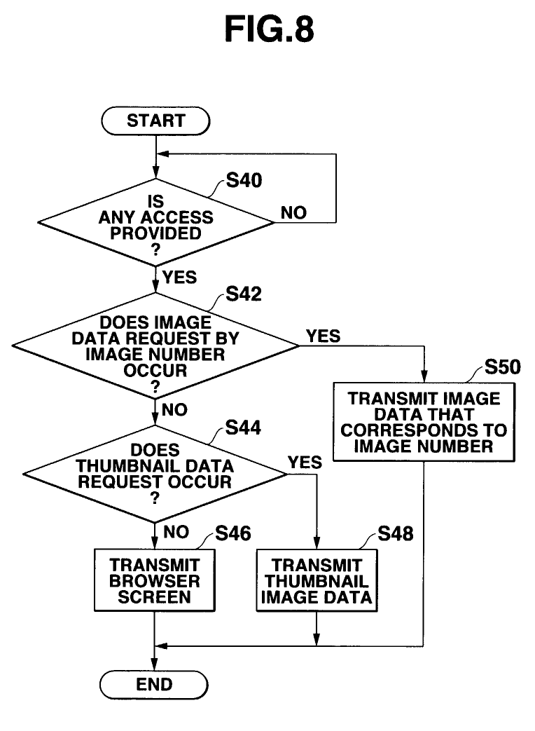

Now, operation of the above described digital print service system will be described in more detail. FIG. 5 and FIG. 6 are flowcharts each illustrating an operation of the portable telephone set 3 according to the first embodiment. FIG. 7 is a flowchart illustrating operation of the print vending machine 4. FIG. 8 is a flowchart illustrating operation of the image service server 1.

First, the user obtains access to the image service server 1 via the network 5 by using the portable telephone set 3 (step S10). At this time, the image service server 1 carries out user authentication by using a telephone number, password or the like registered in advance in the portable telephone set 3. In the image service server 1, it is determined whether or not access from the portable telephone set 3 or print vending machine 4 has been provided (step S40). When external access is provided, it is determined whether or not such external access is an image data request based on an image number (step S42). At this time, when access is provided from the portable telephone set 3, it does not indicate an image data transmission request. Thus, it is then determined whether or not the above external access is a thumbnail image data request (step S44). Here, since no thumbnail image data request occurs, a browser screen for browsing image data stored in the image database 2 is transmitted to the portable telephone set 3 (S46).

In the portable telephone set 3, the user browses image data on the browser screen from the image service server 1 (step S12). The user selects a desired image during browsing (step S14). At this time, one or plural images may be selected. When the user select an image, and carries out predetermined operation, the portable telephone set 3 transmits a thumbnail image data request to the image service server 1.

The image service server 1 having received the thumbnail image data request transmits to the portable telephone set 3 the thumbnail image data of the image which is selected by the user of the portable telephone set 3 (step S48). At this time, the image service server 1 may make a charge for the portable telephone set 3 in response to the download of the thumbnail image data. The charge is added to a charge for the telephone call, and the portable telephone company collects the charge, and makes payment to the company that manages a print service system.

The portable telephone set 3 downloads the thumbnail image data (including image number) from the above image service server 1 (step S16), stores the data in its own storage portion (not shown), and then temporarily disconnects the line (step S18).

Next, the user obtains access to the print vending machine 4 via the network 5 by using the portable telephone set 3 (step S20). At this time, the print vending machine 4 carries out user authentication by the telephone set or password registered in advance in the portable telephone set 3. At the portable telephone set 3, the user selects the thumbnail image data of a desired image (step S22), and makes predetermined operation (presses a predetermined key, or the like), thereby transmitting the image number of the selected thumbnail image data to the print vending machine 4 via the network 5 (step S24). Then, the user disconnects the line (step S26).

In the print vending machine 4, it is determined whether or not a print request has occurred from the portable telephone set 3 via the network 5 (step S30). If the print request occurs, the print bending machine 4 immediately provides access to the image service server 1 via the network 5, and transmits the image data request using the image data number (step S32). At this time, the image service server 1 carries out user utilization by using the telephone number or password of the portable telephone set 3.

In contrast, the image service server 1 having received the image data request using the image number transmits image data that corresponds to the image number transmits to the print vending machine 4 (step S50).

The print vending machine 4 downloads the image data that corresponds to the requested image number from the image service server 1 (step S34), and temporarily stores the data in a predetermined storage device (not shown). Next, in the print vending machine 4, it is determined whether or not the user having requested image data printing has inserted a coin (for printing) in the coin charge portion 409 (step S36). When the user inserts a coin, the vending machine prints out the stored image data (step S38). In this manner, the user receives a print from an arbitrary print vending machine 4.

In the above described first embodiment, although the user uses the portable telephone set 3 as a terminal, the user may use a PHS terminal, a portable personal computer, or a PDA without being limited thereto. Further, although the image number of the thumbnail image data selected by the portable telephone set 3 has been transmitted to the print vending machine 4 via the network 5, the portable telephone set 3 and the print vending machine 4 each may provide a short distance communication function (such as IrDA or Bluetooth, for example) so as to transmit the image number using the short distance communication without involving the network 5. In addition, the print vending machine 4 downloads image data immediately after the print request from the portable telephone set 3 has been made. Thus, actually, it may take some tens of minutes or several hours depending on a distance between the user and the print vending machine 4 or user's convenience until the user visits an installation site of the print vending machine 4 in order to receive a print. Therefore, in reality, the print vending machine 4 holds image data for a predetermined period of time, and may discard the image data if no user visits there after the period has elapsed (that is, no coin is inserted). In this case, the print vending machine 4 may notify the user's portable telephone set 3 that the data has been discarded through e-mail (or that the data will be discarded after several hours from).

Moreover, apart from the above time lag, a print request from a plurality of users is received. Thus, it is required to identify a user who has inserted a coin and which image data is requested for printing by the user. In order to do this, for example, the downloaded image data is stored to be associated with the telephone number or the password of the portable telephone set of the user who has requested printing which is set/registered in advance. In addition, when the user inserts a coin, the telephone number or password of the portable telephone set 3 may be entered. Alternatively, the telephone number or password is transmitted by the portable telephone set 3 dispatching it to a specific telephone number assigned to the print vending machine 4 so that the user may be identified.

In the above described first embodiment, the portable telephone set 3 browses the image data stored in the image database 2 of the image service server 1. Then, desired image data is transmitted from the image service server 1 to the print vending machine 4. This makes it unnecessary to select an image, record the image on a medium, and bring the medium. In addition, the user can receive a print at the print vending machine 4 installed at a neighborhood convenience store or the like even if one is out of home. In addition, it is possible to make a charge for thumbnail browsing and downloading as well as printing.

In the above described first embodiment, although user authentication has been carried out by telephone number and password, an ID number other than such telephone number may be issued. In addition, in the above described first embodiment, although an image has been specified by the image number of a desired image, the thumbnail image data having the image specified data embedded therein itself may be transmitted to the print vending machine 4. Further, although a coin is inserted in the print vending machine 4, thereby collecting a print charge, the image service server 1 may make a charge for such printing. In this case, the charge for print service is collected by adding it to the charge for the telephone call of the portable telephone set 3 at the time when the user selects a desired image (step S14), whereby the collected charge may be paid to the company that manages the print service system. In addition, the thumbnail image data is downloaded to a removable external memory instead of a memory in the portable telephone set 3, and the external memory is directly attached to the print vending machine 4, whereby information for specifying image data (such as image number) may be recognized.

B. Second Embodiment

Now, a second embodiment of the present invention will be described here.

The basic configuration of the second embodiment is substantially similar to that of the first embodiment comprising the image service server 1, image database 2, portable telephone set 3, and print vending machine 4. The above embodiments are different from each other in operation. That is, in the previously described first embodiment, the thumbnail image data is downloaded from the image service server 1 to the portable telephone set 3, and printing is instructed to the print vending machine 4 in accordance with the thumbnail image data. In contrast, in the second embodiment, browsing is carried out over the image service server 1 without downloading the thumbnail image data to the portable telephone set 3, desired image data is directly transmitted from the image service server 1 to the print vending machine 4, and a print instruction is issued. Therefore, in the second embodiment, there is no need to use an image number for identifying image data except for management of image data over the image service server 1.

B-1. Operation of Second Embodiment

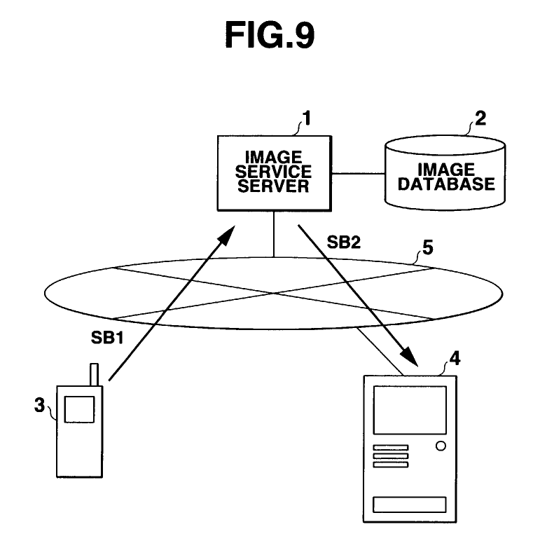

Now, an operation of a digital print service system according to the above described second embodiment will be described here. FIG. 9 is a conceptual view illustrating a general operation of the digital print service according to the second embodiment.

First, a user obtains access to the image service server 1 via the network 5 by using the portable telephone set 3, browses the image data stored in the image database 2 of the image service server 1, and selects a desired image (SB1). The image service server 1 transmits the image data selected by the user to the print vending machine 4 via the network 5 (SB2). The print vending machine 4 receives the image data from the image service server 1, and prints out the image data. In this manner, the user receives a print from the print vending machine 4.

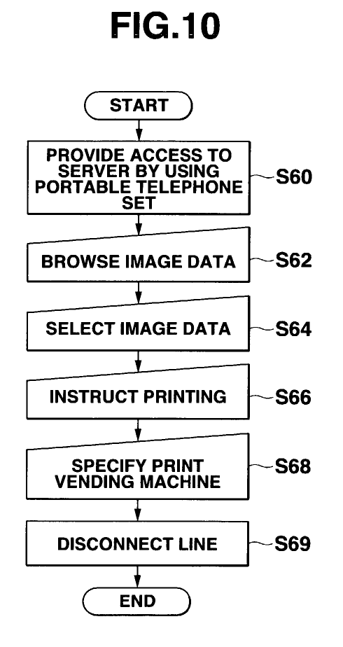

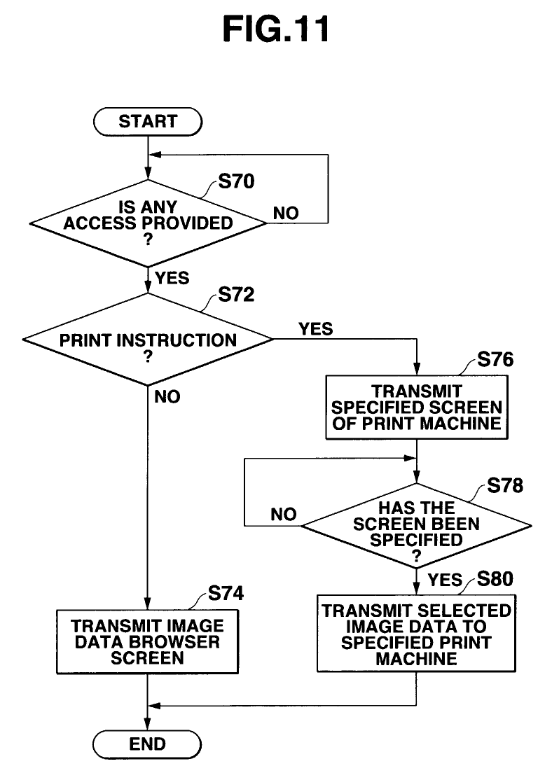

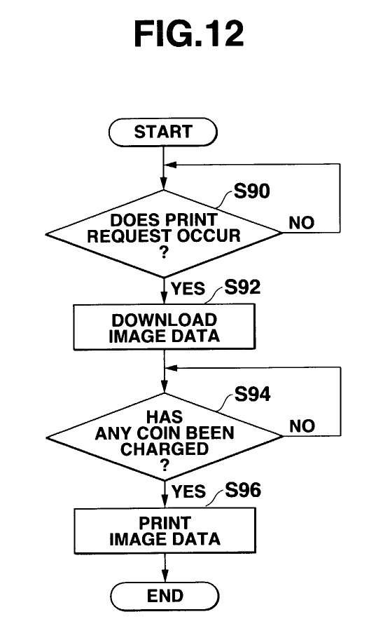

Now, operation of the digital print service system according to the above described second embodiment will be described here. FIG. 10 is a flowchart illustrating operation of the portable telephone set 3 according to the second embodiment. FIG. 11 is a flow chart illustrating operation of the image service server 1. FIG. 12 is a flowchart illustrating operation of the print vending machine 4.

First, the user obtains access to the image service server 1 via the network 5 by using the portable telephone set 3 (step S60). In the image service server 1, it is determined whether or not an access from the portable telephone 3 has been provided via the network 5 (step S70). When external access has been provided, it is determined whether or not such external access is a print instruction (step S72). When the portable telephone set 3 does not issue a print instruction, the image service server 1 transmits the image data browser screen to the portable telephone set 3 (step S74).

In the portable telephone set 3, the user browses image data on the browser screen from the image service server 1 (step S62). The user selects a desired image during browsing (step S64). At this time, one or plural images may be selected. When the user selects an image, and carries out predetermined operation, the portable telephone set 3 transmits a print instruction to the image service server 1 (step S66).

The image service server 1 having received such print instruction transmits a specification screen for specifying the print vending machine 4 to the portable telephone set 3 (step S76). In contrast, the portable telephone set 3 specifies the print vending machine 4 for printing image data on the specification screen (step S68), and disconnects the line (step S69). A method for specifying the print vending machine 4 includes: narrowing on the specification screen based on address of the user's location or assigning an identification number in advance to the print vending machine 4, and then, allowing the identification number to be input.

In the image data server 1, it is determined whether or not the print vending machine has been specified (step S78). When the print vending machine 4 is specified by the portable telephone set 3, a print request is transmitted to the print vending machine 4 for which a print request has been specified, and the previously selected image data is read out from the image database 2, and is transmitted (step S80).

In the print bending machine 4, it is determined whether or not a print request has been made (step S90). If the print request from the image service server 1 has been made, the vending machine receives image data, and temporarily stores the data in a predetermined storage device (not shown) (step S92). Next, in the print vending machine 4, it is determined whether or not the user having requested image data printing has inserted a coin (for printing) (step S94). When the user inserts a coin, the vending machine prints out the stored image data (step S96). In this manner, the user receives a print.

In the above described second embodiment, although the user uses the portable telephone set 3 as a terminal, the user may use a PHS terminal, a portable personal computer, or a PDA without being limited thereto. In addition, in the above described second embodiment as well, image data is discarded or is notified as soon to be discarded in the print vending machine 4 by using a method similar to that according to the above described first embodiment. In addition, the user recognition in the image service server 1 or print vending machine 4 and a correspondence between user and image data are achieved by using a method similar to that according to the previously described first embodiment.

In the above described second embodiment, the portable telephone set 3 browses image data stored in the image database 2 of the image service server 1, and directly transmits desired image data from the image service server 1 to the print vending machine 4. Thus, the thumbnail image data need not be downloaded to the portable telephone set 3, and the burden of a charge for the telephone call upon the user can be reduced. In addition, as in the first embodiment, there is no need to select an image in advance, record the image on a medium, and bring the medium. Further, the user can receive a print at the print vending machine installed at a neighborhood convenience store or the like even if out of home.

In the above described second embodiment, as in the previously described first embodiment, although the user inserts a coin in the print vending machine 4, thereby paying a charge for printing, the image service server 1 may make a charge for such printing. In this case, the charge for print service is collected by adding it to the charge for the telephone call of the portable telephone set when a print instruction is transmitted to the image service server 1 (step S66), thereby making it possible to pay the collected charge to a company that manages the print service system.

What is claimed is:

1. A printing service system comprising:
a service device which comprises a storage portion having a main image and a thumbnail image stored therein;
a portable information device which provides access to the server device via a network to receive a desired thumbnail image and its number from the storage device, and transmits the image number to a printing device, corresponding to the thumbnail image; and
a printing device which downloads and prints the main image which corresponds to the thumbnail image specified from the portable information device from the server device via the network.

2. A printing service system according to claim 1, wherein the portable information device further comprises a display portion to display the thumbnail image and an input portion for a user to input a command.

3. A printing service system according to claim 1, wherein the portable information device further comprises a storage portion which stores a thumbnail image and a display portion to display a thumbnail image.

4. A printing service system according to claim 1, wherein the server stores the main image, thumbnail image, and image number in the storage device in association therewith.

5. A printing service system according to claim 1, wherein the printing device further comprises a coin charge portion to receive payment.

6. A printing apparatus comprising:
a communication portion which carries out external data transmission/receiving via a network;
a control portion which receives information for specifying an image via the communication portion, and externally downloads image data based on information for specifying the received image;
a coin charge portion which receives a coin; and
a printing portion which prints the image data on paper.

7. A printing device according to claim 6, wherein the printing device further comprising a terminal to connect a storage element.

8. A server device comprising:
a first storage portion having stored therein a main image and a thumbnail image corresponding to the main image;
a second storage portion having a program stored therein;
a communication portion connected to a network to connect an external device; and
a control portion which reading out the thumbnail image specified via the network from the first storage portion in accordance with a program stored by the second storage portion, followed by delivering the read out image from the communication portion to an external device via the network, and reads out the main image presented via the network from the first storage portion, followed by delivering the read out image from the communication portion to the external device via the network.

9. A service device program comprising:
a step of transmitting a thumbnail number and an image number that corresponds thereto upon an external request via a network;
a step of externally receiving the image number that corresponds to the thumbnail image via the network; and
a step of externally delivering a larger amount of data than that of a thumbnail, the image corresponding to the received image number via the network.

10. A portable information device program comprising:
a step of providing access from a portable information device to a printing device by a user operation;
a step of causing a user to select a stored thumbnail; and
a step of delivering the image number that corresponds to the thumbnail to the printing device.

11. A portable information device program according to claim 10, further comprising a step of disconnecting a network.

12. A printing service system comprising:
a server device which comprises a storage portion having a main image and a thumbnail image stored therein, the server device externally delivering the main image and thumbnail image and an image number;
a portable information device which provides access to the server device via a network, thereby receiving a desired image number from the storage portion and transmitting the image number to the server device; and
a printing device which downloads and prints the main image from the server device via the network in accordance with a command from the server.

13. A printing service system according to claim 12, wherein the portable information device comprises: a display portion to receive a thumbnail image and number from the server, and further, to display the thumbnail image; and an input portion for a user to select the thumbnail image.

14. A printing service system according to claim 12, wherein the portable information device further comprises a storage portion which stores an image number and a display portion to display a thumbnail image.

15. A printing service system according to claim 12, wherein the server stores the main image and thumbnail image and number in the storage portion in association therewith.

16. A printing service system according to claim 12, wherein the printing device further comprises a coin charge portion to receive a coin.

17. A portable information device program comprising:
a step of providing access from a portable information device to a server via a network by a user operation;
a step of displaying image data delivered from the server;
a step of causing the user to select a desired image from the displayed image;
a step of prompting the user to deliver a print command to the server; and
a step of causing the user to select a printer targeted for printing.

18. A portable information device program according to claim 17, further comprising a step of disconnecting a network.

19. A printing service system comprising:
a server device which comprises a storage portion having a main image and a thumbnail image stored therein;
a portable information device which is provided with storage means for storing a thumbnail image, display means for displaying a thumbnail, and input means for a user to input a command, and which provides access to the server device via a network to receive a desired thumbnail image and its number from the server device, and transmits the image number to a printing device, corresponding to the thumbnail image; and
printing means for downloading and printing the main image which corresponds to the image number specified from the portable information device from the server device via the network.
